(19) United States
(12) Patent Application Publication
(10) Pub. No.: US 2003/0159769 A1
(43) Pub. Date: Aug. 28, 2003

(54) Substrate laminating apparatus and method thereof and substrate detecting apparatus

(75) Inventors: Shinichi Ogimoto, Kanagawa (JP); Hirokazu Masuda, Kanagawa (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: SHIBAURA MECHATRONICS CORPORATION, Yokohama-shi (JP)

(21) Appl. No.: 10/372,453

(22) Filed: Feb. 24, 2003

(30) Foreign Application Priority Data
Feb. 28, 2002 (JP) 2002-055064
Jan. 31, 2003 (JP) 2003-025222

(51) Int. Cl. B32B 31/00

(52) U.S. Cl. 156/64; 156/351; 156/360

(57) ABSTRACT

A substrate laminating apparatus has an upper stage for holding an upper glass substrate and a lower stage for holding a lower glass substrate, and which laminates together the upper glass substrate and the lower glass substrate in a condition that both of the substrates are positioned relative to each other. An image pickup device photographs position detecting marks on the upper and lower glass substrates, and a moving device changes a relative distance between the image pickup device and the upper/lower glass substrates. A data acquiring device acquires data about the relative distance between the upper/lower glass substrates and the image pickup device, and a control device controls the moving device based on data about the relative distance.

### BACKGROUND OF THE INVENTION

1. Field of the Invention

The present invention relates to a substrate laminating apparatus preferably used for manufacturing a liquid crystal display panel, a substrate laminating method and a substrate detecting apparatus.

2. Description of the Related Art

As described in Japanese Patent Application Laid-Open No. 2000-66163, a substrate laminating apparatus comprises an upper stage for holding an upper glass substrate and a lower stage for holding a lower glass substrate, and laminates the upper glass substrate with the lower glass substrate in their positioning state.

According to a conventional technology, position detecting marks on the upper glass substrate and the lower glass substrate are photographed with an image pickup device in order to match positions of the upper glass substrate and the lower glass substrate, a relative position deviation is detected between the upper glass substrate and the lower glass substrate based on the photographed image and then, an upper stage and a lower stage are moved in a facial direction of the substrate so as to correct the relative position deviation between the upper glass substrate and the lower glass substrate based on a detection result.

However, when the position detecting marks on the upper glass substrate and the lower glass substrate are photographed with the image pickup device according to the conventional technology, sometimes the position detecting marks cannot be placed within a focal depth of the image pickup device disposed at a constant point relative to the upper stage and the lower stage because there is an error in plate thickness of the upper glass substrate or the lower glass substrate, so that detection of the relative position deviation between the upper glass substrate and the lower glass substrate based on image data taken by the image pickup device may be disabled. Consequently, the substrates cannot be laminated with each other, and the rate of operation of the substrate laminating apparatus is lowered.

### SUMMARY OF THE INVENTION

An object of the present invention is to provide an apparatus and method for securely photographing the position detecting mark on a substrate using an image pickup device. Consequently, the present invention aims to prevent from reducing the rate of operation of substrate laminating work.

To achieve the above object, according to an aspect of the present invention, there is provided a substrate laminating apparatus having an upper stage for holding an upper substrate and a lower stage for holding a lower substrate, and laminating together the upper substrate and the lower substrate in a condition that both of the substrates are positioned relative to each other. The substrate laminating apparatus further comprises an image pickup device for photographing a position detecting mark at least on one substrate of the upper and lower substrates; a moving device for changing a relative distance between the image pickup device and at least one substrate; a data acquiring device which acquires data about the relative distance between at least one substrate and the image pickup device; and a control device for controlling the moving device based on acquired data about the relative distance.

According to another aspect of the present invention, there is provided a substrate laminating apparatus having an upper stage for holding an upper substrate and a lower stage for holding a lower substrate, and laminating together the upper substrate and the lower substrate in a condition that both of the substrates are positioned relative to each other. The substrate laminating apparatus further comprises an image pickup device for photographing a position detecting mark at least on one substrate of the upper and lower substrates; a moving device for changing a relative distance between the image pickup device and at least one substrate; an image processing device for computing a degree of coincidence between a mark pattern acquired from the image pickup device and a set reference mark pattern; and a control device for controlling the moving device based on the computed degree of coincidence.

According to still another aspect of the present invention, there is provided a substrate laminating method for laminating together an upper substrate held by an upper stage with a lower substrate held by a lower stage in a condition that both of the substrates are positioned relative to each other. The substrate laminating method comprises the steps of photographing a position detecting mark of at least one substrate of the upper and lower substrates; computing a degree of coincidence between a photographed mark pattern and a set reference mark pattern; and changing the relative distance between the image pickup device and at least one substrate based on a computed degree of coincidence.

According to yet still another aspect of the present invention, there is provided a substrate laminating apparatus having an upper stage for holding an upper substrate and a lower stage for holding a lower substrate, and laminating together the upper substrate and the lower substrate. The substrate laminating apparatus further comprises an image pickup device for photographing a position detecting mark at least on one substrate of the upper and lower substrates; a moving device for changing a relative distance between the image pickup device and at least one substrate; a thickness measuring device for measuring the thickness of at least one substrate; and a control device for controlling the moving device based on a measurement result of the thickness measuring device.

According to a further aspect of the present invention, there is provided a substrate laminating method for laminating together an upper substrate held by an upper stage and a lower substrate held by a lower stage in a condition that both of the substrates are positioned relative to each other. The substrate laminating method comprises the steps of measuring the thickness of a held substrate; adjusting a relative distance between the image pickup device and at least one substrate based on the measured substrate thickness; and photographing a position detecting mark of at least one substrate.

According to a still further aspect of the present invention, there is provided a substrate laminating method for laminating together an upper substrate held by an upper stage and a lower substrate held by a lower stage in a condition that both of the substrates are positioned relative to each other. The substrate laminating method comprises the steps of measuring the thickness of the upper substrate and the lower substrate; and adjusting a relative distance between the image pickup device and the substrate based on a measured substrate thickness so that a distance between both of the substrates becomes a predetermined value and a distance between the both substrates and the image pickup device becomes a target relative distance.

According to a yet still further aspect of the present invention, there is provided a substrate detecting apparatus for detecting the position of a substrate, comprising an image pickup device for photographing a position detecting mark of a substrate; a moving device for changing a relative distance between the image pickup device and the substrate; a data acquiring device which acquires data about the relative distance between the substrate and the image pickup device; and a control device for controlling the moving device based on acquired data about the relative distance.

### BRIEF DESCRIPTION OF THE DRAWINGS

The present invention will be more fully understood from the detailed description given below and from the accompanying drawings which should not be taken to be a limitation on the invention, but are for explanation and understanding only.

FIG. 1 is a schematic diagram showing a substrate laminating apparatus according to the present invention;

FIG. 2 is a control block diagram of the apparatus of FIG. 1;

FIG. 3 is a schematic diagram showing another substrate laminating apparatus according to the present invention; and

FIG. 4 is a control block diagram of the apparatus of FIG. 3.

### DETAILED DESCRIPTION

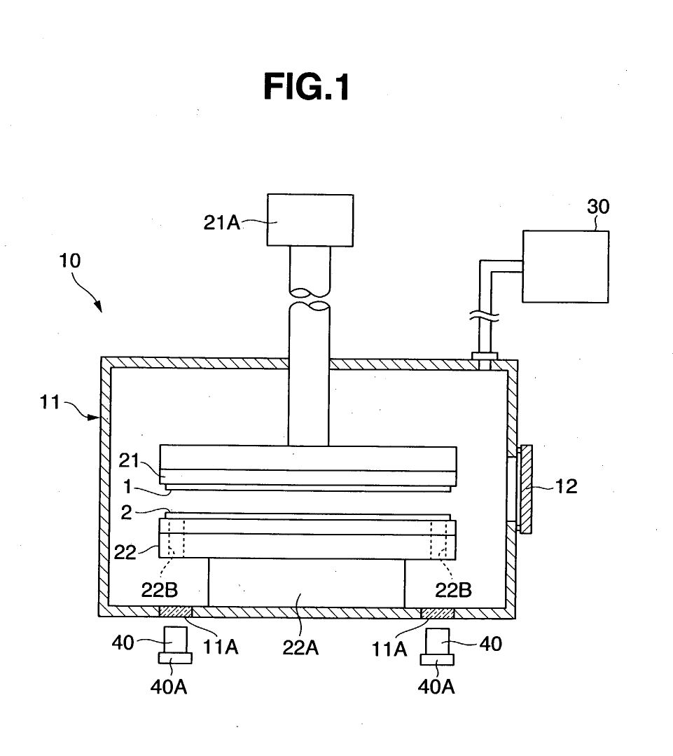

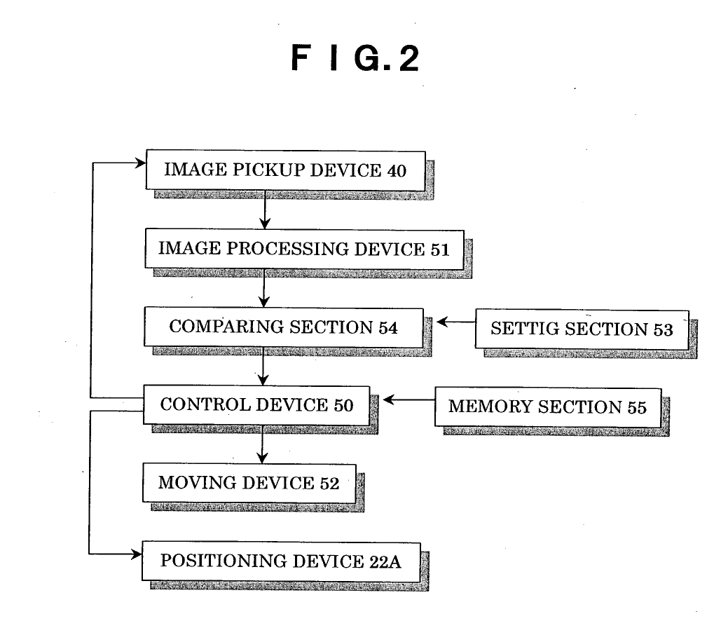

First Embodiment—FIGS. 1 and 2

In the substrate laminating apparatus 10, the upper glass substrate 1, and the lower glass substrate 2 loaded a liquid crystal in a region surrounded by an adhesive (sealing adhesive—not shown) are received from a preceding process (such as that process described in copending U.S. application Ser. No. ______ filed on Feb. 14, 2003 (U.S. attorney docket number 03070/LH), Inventor: Shingo TAMAI, assigned to the same assignee as the present application, claiming the priority of Japanese Application No. 2002-042379 filed in Japan on Feb. 19, 2002, the entire contents of both of which are incorporated herein by reference). Thereafter, the upper glass substrate 1 and the lower glass substrate 2 are laminated with each other in their positioning state so as to produce a cell (liquid crystal display panel).

As shown in FIG. 1, the substrate laminating apparatus 10 comprises a closed container 11, an upper stage 21, a lower stage 22, a pressure adjusting device 30 and image pickup devices 40.

The closed container 11 encloses the upper stage 21 and the lower stage 22 and then, the upper glass substrate 1 and the lower glass substrate 2 carried from a preceding process are inserted through a shutter 12.

The upper stage 21 is capable of holding the upper glass substrate 1 and is lifted up/down by an upper stage moving device 21A.

The lower stage 22 is capable of holding the lower glass substrate 2 and is moved horizontally, rotated and lifted up/down by a lower stage moving device 22A.

The pressure adjusting device 30 adjusts a pressure inside the closed container 11 and comprises for example, a vacuum source and an 5 air supply source. The atmosphere inside the closed container 11 is depressurized to a vacuum state with the vacuum source and then, the evacuated atmosphere inside the closed container 11 is pressurized to an atmospheric pressure with the air supply source.

The image pickup devices 40 each photograph a position detecting mark on or attached to each of four corners of the upper glass substrate 1 and the lower glass substrate 2. Each image pickup device is disposed corresponding to the four corners of each of the upper glass substrate 1 held by the upper stage 21 and the lower glass substrate 2 held by the lower stage 22 on the bottom of the closed container 11. 15 Corresponding to the respective image pickup devices 40, the closed container 11 has peep windows 11A and the lower stage 22 has through holes 22B. The respective image pickup devices 40 photograph the position detecting marks on the upper glass substrate 1 and the lower glass substrate 2 through these peep windows 11A and through holes 22B. The position detecting marks are attached to laminating faces provided on the upper glass substrate 1 and the lower glass substrate 2, the laminating faces facing each other. The image pickup devices 40 are lifted up or moved down by the camera moving devices 40A.

The laminating operation for laminating the upper glass substrate 1 with the lower glass substrate 2 using the substrate laminating apparatus 10 is as follows. First, with the upper glass substrate 1 and the lower glass substrate 2 held by the upper stage 21 and the lower stage 22, respectively, the inside of the closed container 11 is depressurized to a vacuum state by the pressure adjusting device 30. The position detecting marks on the upper glass substrate 1 and the lower glass substrate 2 are read out (i.e., photographed) by the image pickup devices 40 so as to detect a relative position deviation of the upper glass substrate 1 and the lower glass substrate 2 in each direction. The lower stage moving device 22A (positioning device) is controlled so as to correct this relative position deviation, so that the upper stage 21 and the lower stage 22 are moved relatively with respect to the facial directions of the substrates 1, 2, so as to match the positions of the upper glass substrate 1 and the lower glass substrate 2. Then, the upper stage 21 is moved down with the upper stage moving device 21A so as to laminate the upper glass substrate 1 to the lower glass substrate 2 through the adhesive (not shown) under an atmosphere depressurized by the pressure adjusting device 30. Laminating together the glass substrates under such a depressurized atmosphere avoids mixing of air into the liquid crystal material (not shown) which was supplied onto the lower glass substrate 2 preliminarily.

The inside of the closed container 11 is then pressurized to the atmospheric pressure by the pressure adjusting device 30 and the upper glass substrate 1 and the lower glass substrate 2 are repositioned with the image pickup devices 40 and the lower stage moving device 22A if necessary. After that, holding of the upper glass substrate 1 and the lower glass substrate 2 with the upper stage 21 and the lower stage 22 is released and then, the upper glass substrate 1 and lower glass substrate 2 (cell) laminated together is taken out of the closed container 11.

As shown in FIG. 2, the substrate laminating apparatus 10 comprises a control device 50, an image processing device 51, a moving device 52, a setting section 53, a comparing section 54 and a memory section 55 so as to photograph the position detecting marks on the upper glass substrate 1 and the lower glass substrate 2 with image pickup devices 40 securely when the above-described positioning about the upper glass substrate 1 and the lower glass substrate 2 is carried out as shown in FIG. 2.

The image processing device 51 computes the degree of coincidence between a photographed mark pattern and a set reference mark pattern (hereinafter referred to just as degree of coincidence) for the position detecting marks of the upper glass substrate 1 and the lower glass substrate 2 photographed with the image pickup devices 40.

The moving device 52 comprises the upper stage moving device 21A of the upper stage 21, the camera moving device 40A and the like and adjusts the relative positions between the image pickup devices 40 and the upper stage 21 or the lower stage 22 so as to change a relative distance between the image pickup devices 40 and the upper glass substrate 1 or the lower glass substrate 2.

The setting section 53 sets up an allowable value about the degree of coincidence in order to determine whether or not the relative distance between the image pickup devices 40 and the upper glass substrate 1 or the lower glass substrate 2 is good (whether or not the position detecting marks of the substrates 1, 2 enters within the focal depth of the image pickup devices 40).

The comparing section 54 compares the degree of coincidence computed by the image processing device 51 with an allowable value set up by the setting section 53.

The memory section 55 sets up a condition of a relative distance changing amount, its relative distance changing direction and the like necessary for changing the relative distance between the image pickup devices 40 and the upper glass substrate 1 or the lower glass substrate 2. More specifically, a moving amount d, a moving device to be driven (upper stage moving device 21A of this embodiment) and a moving direction for initial correction (up or down and “down” in this embodiment) are set up about the upper glass substrate 1. If the degree of coincidence of a photographed mark pattern is deviated from its 10 allowable value, the upper stage 21 is moved downward with a predetermined moving amount d. The moving direction for the second time and following times is determined based on a comparison of the initially computed degree of coincidence with a computed degree of coincidence after correction of the relative distance and if the degree of coincidence is increased, the upper stage 21 is moved in the same direction and if the degree of coincidence is decreased, it is moved in an opposite direction. The condition is set up about the lower glass substrate 2 according to the same procedure. A frequency of photographings to obtain an excellent relative distance between the image pickup devices 40 and the substrates 1, 2, and also to be allowed for the image pickup devices 40 (hereinafter, referred to as allowable frequency) is set up in the memory section 55.

The control device 50 obtains a comparison result of the comparing section 54 and then controls the moving device 52 on a condition that the degree of coincidence computed by the image processing device 51 is deviated from a set up allowable value. The relative distance between the image pickup devices 40 and the upper glass substance 1/the lower glass substrate 2 is changed by just a setting amount determined in the memory section 55. Then, the control device 50 photographs the position detecting marks on the upper glass substrate 1 and the lower glass substrate 2 again by the image pickup devices 40 and the degree of coincidence between the photographed mark pattern and a reference mark pattern is computed again by the image processing device 51.

Therefore, the procedure for positioning the upper glass substrate 1 and the lower glass substrate 2 with the control device 50 is 10 as follows. First, it is assumed that the position detecting mark attached to the lower glass substrate 2 held by the lower stage 22 exists within the focal depth of the image pickup device 40 and a case where only the position detecting mark on the upper glass substrate 1 held by the upper stage 21 is out of the focal depth of the image pickup device 40 will be described below.

(1) The position detecting marks of the upper glass substrate 1 and the lower glass substrate 2 are simultaneously photographed with the image pickup devices 40.

(2) The degree of coincidence between the photographed mark pattern about the upper glass substrate 1 and a set reference mark pattern is computed with the image processing device 51. Then, the degree of coincidence computed by the image processing device 51 and the allowable value set up by the setting section 53 are compared by the comparing section 54. If the comparison result of the comparing section 54 is good (the degree of coincidence is within its allowable value range), the processing proceeds to (5) and otherwise, proceeds to (3).

(3) Whether or not the frequency of photographings by the image pickup device 40 exceeds an allowable frequency set in the memory section 55 is determined. Unless it exceeds the allowable frequency, the processing proceeds to (4) and if it does, an operator call processing of positioning disabled is carried out.

(4) The moving device 52 is controlled using the set data in the memory section 55.

(4-1) A relative distance between the image pickup device 40 and the upper stage 21 is adjusted by the moving device 52 and the relative distance between the image pickup device 40 and the upper glass substrate 1 is changed just by a setting amount specified in the memory section 55. In a preceding example, the upper stage 21 is changed only by the moving amount d in a direction of approaching to the image pickup devices 40.

(4-2) After changing the relative distance in the above (4-1), the position detecting marks on the upper glass substrate 1 and the lower glass substrate 2 are photographed again and the degree of coincidence of the photographed mark pattern about the upper glass substrate 1 is computed with the image processing device 51 again.

(4-3) The degree of coincidence computed in the above (4-2) increases over the last computed degree of coincidence and if the comparison result of the comparing section 54 is good, the processing proceeds to (5). If the comparison result is wrong although the degree of coincidence increases, the relative distance is changed by every moving amount d in a direction that the upper glass substrate 1 approaches the image pickup device 40 by the moving device 52. Each time, computation of the degree of coincidence with the image pickup device 51 and comparison by the comparing section 54 is repeated within an allowable frequency until the comparison result becomes good. If the comparison result by the comparing section 54 is good, the processing proceeds to (5).

(4-4) The degree of coincidence computed again in the above described (4-2) drops from the degree of coincidence computed previously and if the comparison result of the comparing section 54 is wrong, the upper stage 21 is moved by moving section 52, so as to change the relative distance by every moving amount d in a direction that the upper stage 21 leaves (i.e., moves away from) the image pickup devices 40. Each time, computation of the degree of coincidence with the image processing device 51 and comparison with the comparing section 54 is repeated within the allowable frequency until the comparison result becomes good. If the comparison result by the comparing section 54 becomes good, the processing proceeds to (5).

(5) As described above, a relative position deviation in facial directions between the upper glass substrate 1 and the lower glass substrate 2 is detected based on image data about the position detecting marks of the upper glass substrate 1 and the lower glass substrate 2 photographed by the image pickup device 40. Then, the lower stage moving device 22A is controlled so as to correct this relative position deviation, so that the upper stage 21 and the lower stage 22 are moved relatively in the facial directions of the substrates 1, 2. Consequently, the upper glass substrate 1 and the lower glass substrate 2 are correctly positioned relative to each other.

According to the first embodiment, although an example in which the position detecting mark of the lower glass substrate 2 held by the lower stage 22 is always within the focal depth of the image pickup devices 40 has been described for convenience of description, if there is a possibility that the position detecting marks of the upper and lower glass substrates 1, 2 are out of the focal depth of the image pickup devices 40, a following countermeasure is possible.

That is, if the degree of coincidence of the photographed mark patterns of both the substrates 1, 2 is deviated from the allowable value, this countermeasure is enabled by setting a condition for adjusting the relative distance between the substrates 1, 2 and the image pickup devices 40 in the memory section 55. More specifically, first, the upper stage moving device 21A is controlled by the moving amount d so as to make the degree of coincidence of the mark patterns in the upper glass substrate 1 exist within the allowable value range according to the above-described steps (1)-(4). After that, the lower stage moving device 22A is controlled by the moving amount d so that the degree of coincidence of the mark pattern in the lower glass substrate 2 is within the allowable value range following the same steps (2)-(4). In the meantime, if the degree of coincidence of the photographed mark patterns of both the substrates 1, 2 is deviated from the allowable value range, it can be considered that the position detecting mark attached to the upper glass substrate 1 may be deviated upward relative to the focal depth of the image pickup devices 40 and the position detecting mark attached to the lower glass substrate 2 may be deviated downward relative to the focal depth of the image pickup devices 40. Therefore, the initial moving directions of the upper and lower stages 21, 22 by the moving devices 21A, 22A should be set up in a direction that the relative distance between the stages 21 and 22 is decreased.

Alternatively, it is permissible to adjust the relative distance between the image pickup devices 40 and the upper/lower glass substrates 1, 2 by lifting up or moving down the image pickup devices 40. That is, in the memory section 55 preliminarily, a condition for moving the image pickup devices 40 upward by the moving amount d by the camera moving device 40A is set up for the upper glass substrate 1 and then, a condition for moving the image pickup devices 40 downward by the moving amount d is set up for the lower glass substrate 2. In the above-described step (2), the degree of coincidence between the photographed mark patterns of the upper and lower glass substrates 1, 2 is computed and consequently, if only the degree of coincidence of the photographed mark pattern of the upper glass substrate 1 is out of its allowable value, the relative distance between the substrates 1, 2 and the image pickup devices 40 is adjusted according to a condition corresponding to the upper glass substrate 1 set up in the memory section 55. If only the degree of coincidence of the photographed mark pattern of the lower glass substrate 2 is out of the allowable value, the relative distance between the substrates 1, 2 and the image pickup devices 40 is adjusted according to a condition corresponding to the lower glass substrate 2 stored in the memory section 55. If both the degrees of coincidence of the photographed mark patterns of both the substrates 1, 2 are out of the allowable values, it is determined that positioning is disabled and then, an operator call is carried out.

The above-described embodiment has the following operational features:

(1) The position detecting marks of the upper and lower glass substrates 1, 2 are photographed (i.e., image detected) and the degree of coincidence between a photographed mark pattern and a set reference mark pattern is computed. Based on this computed degree of coincidence, the relative distance between the image pickup devices 40 and the upper glass substrate 1, the lower glass substrate 2 is changed, so that the position detecting marks of the upper and lower glass substrates 1, 2 can be brought into the focal depth of the image pickup devices 40 securely.

(2) An allowable value for the degree of coincidence is set up and when the computed degree of coincidence is out of the set allowable value, the relative distance between the upper, lower glass substrates 1, 2 and the image pickup devices 40 is changed only by an amount set preliminarily and the position detecting marks of the upper and lower glass substrates 1, 2 can be brought into the focal depth of the image pickup devices 40 securely and effectively.

Second Embodiment—FIGS. 1 and 2

To photograph the position detecting marks of the upper glass substrate 1 and the lower glass substrate 2 securely with the image pickup devices 40, the substrate laminating apparatus 10 of the second embodiment comprises the control device 50, the image processing device 51, the moving device 52, the setting section 53, the comparing section 54 and the memory section 55 which are the same as those of the first embodiment.

The second embodiment is different from the first embodiment in that the memory section 55 stores data expressing each relative distance between the upper glass substrate 1, lower glass substrate 2 and the image pickup devices 40 and its corresponding degree of coincidence. The control device 50 sets up a relative distance changing amount between the substrates 1, 2 and the image pickup devices 40 by the moving device 52 according to data stored in the memory section 55.

In the meantime, data expressing the relation between the relative distance and the degree of coincidence can be obtained, for example, by experiment. That is, by changing the relative distance between the substrates 1, 2 and the image pickup devices 40 by every specified distance, data about the mark patterns measured at each relative distance is created. Then, an approximate expression expressing the relation between the relative distance and the degree of coincidence is obtained based on this data and this approximate expression is used as data expressing the relation between the relative distance and the degree of coincidence.

Therefore, according to the second embodiment, the positioning procedure for the upper glass substrate 1 and the lower glass substrate 2 by the control device 50 is carried out as follows. For a description of this embodiment, it is assumed that the position detecting marks of the lower glass substrate 2 held by the lower stage 22 exist within the focal depth of the image pickup devices 40 like the first embodiment.

(1) The position detecting marks of the upper glass substrate 1 and the lower glass substrate 2 are photographed (image detected) with the image pickup devices 40.

(2) The degree of coincidence between the mark pattern photographed about the upper glass substrate 1 and a set reference mark pattern is computed by the image processing device 51. Then, the degree of coincidence computed by the image processing device 51 and an allowable value set in the setting section 53 are compared by the comparing section 54. If a comparison result of the comparing section 54 is good (if the degree of coincidence exists within the allowable value), the processing proceeds to (5) and otherwise, the processing proceeds to (3).

(3) Whether or not the photographing frequency by the image pickup devices 40 exceeds an allowable frequency set up in the memory section 55 is determined. Unless it exceeds the allowable frequency, the processing proceeds to (4) and if so, an operator call is carried out because positioning is disabled.

(4) The moving device 52 is controlled according to memory data in the memory section 55.

(4-1) The memory data of the memory section 55, namely, data expressing the relation about the relative distance between the upper glass substrate 1 and the image pickup devices 40 and its corresponding degree of coincidence is used. The degree of coincidence computed by the image processing device 51 in the above (2) is referred to the above described data and a current relative distance between the upper glass substrate 1 and the image pickup devices 40 is estimated.

(4-2) When the degree of coincidence computed by the image processing device 51 is within the allowable value range, a target relative distance between the upper glass substrate 1 and the image pickup devices 40 is estimated from the above-described (4-1) data in the memory section 55. The relative positions of the image pickup devices 40 and the upper stage 21 are adjusted with the moving device 52 so that the current relative distance described in the above (4-1) is in a target relative distance, and the relative distance between the image pickup devices 40 and the upper glass substrate 1 is changed and then processing returns to the above-described (1).

(5) As described above, the relative position deviations in facial directions of the upper glass substrate 1 and the lower glass substrate 2 are detected based on image data about the position detecting marks of the upper glass substrate 1 and lower glass substrate 2 photographed by the image pickup devices 40 and then, the lower stage moving device 22A is controlled so as to correct this relative position deviation. The upper stage 21 and lower stage 22 are moved relatively in the facial directions of the substrates 1, 2 so as to match positions of the upper glass substrate 1 and the lower glass substrate 2.

According to this embodiment, data about the relation between each relative distance between the upper/lower glass substrates 1, 2 and the image pickup devices 40 and its corresponding degree of coincidence is stored and a relative distance change amount between the upper glass substrate 1 and the image pickup devices 40 corresponding to an amount of deviation of a computed degree of coincidence from its allowable value can be grasped. Therefore, the position detecting mark of the upper glass substrate 1 can be placed within the focal depth of the image pickup devices 40 securely and effectively.

According to this second embodiment, although data about the relation between each relative distance between the upper/lower glass substrates 1, 2 and the image pickup devices 40 and its corresponding degree of coincidence is stored in the memory section 55, an adjustment amount for the relative distance between the image pickup devices 40 and upper/lower glass substrates 1, 2 corresponding to each degree of coincidence computed by the image processing device 51 may be stored instead of this data. In this case, according to the procedure (4) of the second embodiment, when the image processing device 51 computes the degree of coincidence, the control device 50 obtains the adjustment amount of the relative distance between the image pickup device 40 and the upper (lower) glass substrate 1 (2) from the data of the memory section 55 and the relative distance between the image pickup devices 40 and the upper/lower glass substrates 1, 2 is changed only by the obtained adjustment amount.

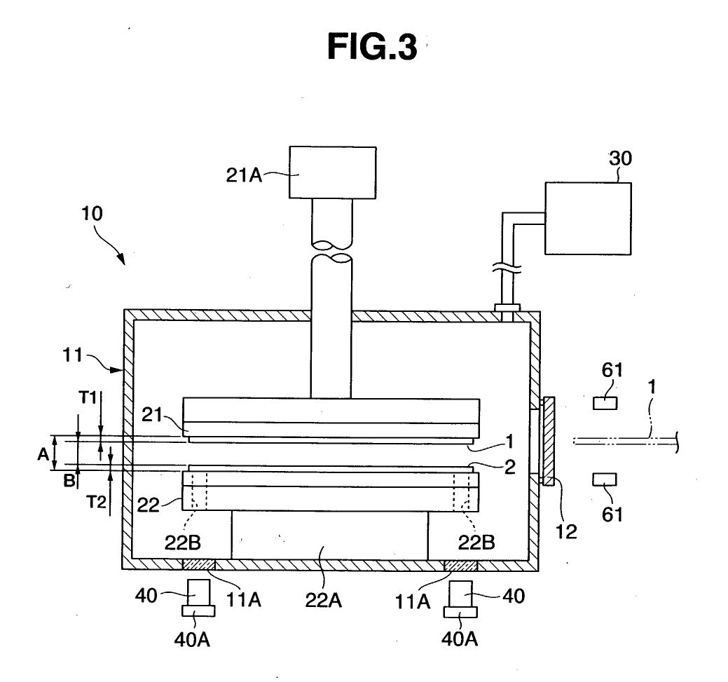

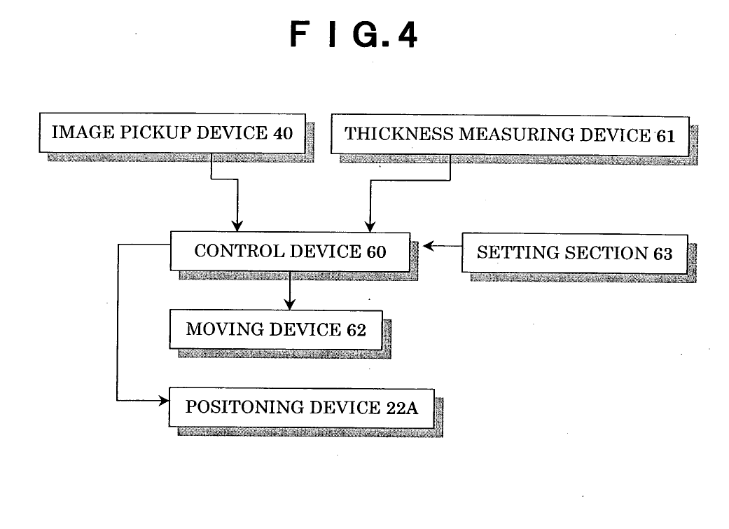

Third Embodiment—FIGS. 3 and 4

In the third embodiment of FIGS. 3 and 4, the same reference numerals as used in FIGS. 1 and 2 are used to denote the same or similar elements.

The substrate laminating apparatus 10 of the third embodiment further comprises a control device 60 (FIG. 4), a thickness measuring device 61 (FIG. 3), a moving device 62 (FIG. 4) and a setting section 63 (FIG. 4) in order to photograph the position detecting marks on the upper glass substrate 1 and the lower glass substrate 2 with the image pickup devices 40 securely.

The thickness measuring device 61 measures the thicknesses T1, T2 of the upper and lower glass substrates 1, 2. The thickness measuring device 61 has a pair of sensors (see FIG. 3) disposed at positions along an insertion path to the closed container 11 for the substrates 1, 2 such that the sensors oppose each other as if they sandwich substrates 1, 2 carried along the insertion path from above and below. Substrate 1 is shown by chain lines in FIG. 3, and the substrate 2 is subsequently fed in. As the sensor of the thickness measuring device 61, for example, a reflection type ultrasonic sensor may be used and the thicknesses T1, T2 of the substrates 1, 2, respectively, are measured according to an output value from each sensor when the substrates 1, 2 are passed through a gap between the pair of sensors. According to this embodiment, although the thickness substantially in the center portion of the substrates 1, 2 is measured on an assumption that the thickness of a single substrate is equal (i.e., constant), there is a possibility that a single substrate may have disparity in its thickness. In such case, it is permissible to measure the thickness of the portions of the substrate corresponding to the position detecting marks on the substrates 1, 2 and to employ an average value thereof. As the sensor, it is permissible to employ any type of sensors including a contact type sensor, if it is capable of measuring the thickness of the substrates 1, 2, as well as a non-contact type sensor.

The moving device 62 (FIG. 4) comprises the upper stage moving device 21A of the upper stage 21, the camera moving device 40A of the image pickup devices 40 and the like. The moving device 62 adjusts a relative position between the image pickup devices 40 and the upper stage 21 or the lower stage 22. Consequently, a relative distance between the image pickup devices 40 and the substrates 1, 2 is changed.

The setting section 63 (FIG. 4) sets up a target relative distance M (focal distance of the image pickup devices 40) between the image pickup devices 40 and a laminating face marked with the position detecting mark on the upper glass substrate 1 or the lower glass substrate 2. Also, a setting interval B that allows both of the substrates 1, 2 to approach each other up to the nearest positions before the laminating together is set up.

The control device 60 (FIG. 4) controls the moving device 62 based on a measuring result of the thickness measuring device 61. More specifically, the moving device 62 adjusts the relative positions between the image pickup devices 40 and the upper stage 21 or the lower stage 22 so that a distance between the image pickup devices 40 and the center position between the upper stage 21 and the lower stage 22, becomes the target relative distance M set up on the setting section 63. Further, the moving device 62 adjusts the relative positions of the image pickup devices 40 and the upper stage 21 or the lower stage 22 so that the interval between the laminating faces marked with the position detecting marks on the substrates 1, 2 becomes the setting interval B. At this time, the relative distance A between the upper stage 21 and the lower stage 22 is A=B+T1+T2 (see FIG. 3).

Therefore, the procedure for positioning the upper glass substrate 1 and the lower glass substrate 2 with the control device 60 is as follows.

(1) The thickness T1, T2 of the upper glass substrate 1 and the lower glass substrate 2, respectively, are measured with the thickness measuring device 61.

(2) The relative distance A between the upper stage 21 and the lower stage 22 is computed based on the measured thicknesses T1, T2 of the substrates 1, 2. Then, the moving device 62 is controlled, so that the interval between the upper stage 21 and the lower stage 22 is the relative distance A, namely, an interval between the laminating faces marked with the position detecting marks on both the substrates 1 and 2 is the setting distance B and a distance between the center position between the upper stage 21 and lower stage 22 and the image pickup devices 40 is the target relative distance M (focal distance of the image 25 pickup devices 40). Consequently, the position detecting marks on the upper and lower substrates 1, 2 are disposed within the focal depth of the image pickup devices 40.

(3) After the positions of the upper glass substrate 1 and the lower glass substrate 2 relative to the image pickup devices 40 are adjusted in the above (2), the position detecting marks on the substrates 1, 2 are simultaneously photographed with the image pickup devices 40. Then, as described above, relative position deviations in facial directions of the upper glass substrate 1 and the lower glass substrate 2 are detected based on image data about the position detecting marks of the substrates 1, 2 photographed with the image pickup devices 40 and then, the lower stage moving device 22A is controlled so as to correct this relative position deviation. The upper stage 21 and the lower stage 22 are moved relatively in facial directions of the substrates 1, 2 so as to match the positions of the upper glass substrate 1 and the lower glass substrate 2.

The above-described third embodiment has the following operational features:

(1) The relative distance between the image pickup device 40 and the upper/lower glass substrates 1, 2 is adjusted based on measured thicknesses of the upper glass substrate 1 and lower glass substrate 2, so that the position detecting marks of the upper glass substrate 1 and lower glass substrate 2 can be brought into the focal depth of the image pickup devices 40 securely.

(2) The relative distance between the image pickup devices 40 and the-upper/lower glass substrates 1, 2 is adjusted so that the distance between the glass substrates 1 and 2 turns to a predetermined value, based on the measured thicknesses of the upper and lower glass substrates 1, 2 in the above (1). Consequently, the position detecting marks of the upper and lower glass substrates 1, 2 can be brought into the focal depth of the image pickup devices 40 securely and effectively.

According to the feature (2) of the third embodiment, if the relation between the focal depth of the image pickup devices 40 and the setting distance B is focal depth<setting distance B, excellent photographed images of the position detecting marks on the upper and lower substrates 1, 2 cannot be obtained by the image pickup devices 40 at the same time. However, the position detecting marks of the respective substrates 1, 2 can be brought in by the image pickup devices 40 individually. More specifically for example, the image pickup devices 40 are lifted up or moved down based on a measurement result of the thickness of any one substrate so that a distance between the image pickup devices 40 and a face marked with the position detecting mark on one substrate is the target relative distance (focal distance of the image pickup devices 40) and then, the position of the position detecting mark is detected with this state. Next, the image pickup devices 40 are lifted up or moved down based on the measurement result of the thickness of the other substrate so that the distance between the image pickup devices 40 and the face marked with the position detecting mark on the other substrate is the target relative distance (focal distance of the image pickup devices 40) and then the position of the position detecting mark is detected with this state. Consequently, the image pickup devices 40 can obtain a further effect of improvement in the position detecting accuracy because it can be considered that their focal position can obtain the clearest image although within the same focal depth.

According to a feature of the present invention, data concerning the relative distance between the substrate and the image pickup device is acquired and the relative distance between the image pickup device and the substrate is changed based on data about this relative distance. Consequently, a position detecting mark of the substrate can be brought into the focal depth of the image pickup device securely. As a result, the position detecting mark of the substrate can be photographed with the image pickup device securely.

According to another feature of the present invention, a position detecting mark of the substrate is photographed and the degree of coincidence between the photographed mark pattern and the set reference mark pattern is computed. The relative distance between the image pickup device and the substrate is changed based on the computed degree of coincidence and the position detecting mark of the substrate can be brought into the focal depth of the image pickup device securely.

According to still another feature of the present invention, an allowable value for the degree of coincidence is set up and if the computed degree of coincidence is deviated from the set allowable value, the relative distance between the substrate and the image pickup device is changed by a predetermined amount. Consequently, the position detecting mark of the substrate can be brought into the focal depth of the image pickup device securely.

According to yet another feature of the present invention, data expressing the relation between the relative distance between the substrate and the image pickup device or its relative distance adjustment amount and corresponding degree of coincidence is stored and the relative distance changing amount between the substrate and the image pickup device can be grasped immediately by the computed degree of coincidence. Therefore, the position detecting mark on the substrate can be brought into the focal depth of the image pickup device securely and effectively.

According to a further feature of the present invention, the relative distance between the image pickup device and the substrate is adjusted based on a measured thickness of the substrate and the position detecting mark of the substrate can be brought into the focal depth of the image pickup device securely.

According to a still further feature of the present invention, the relative distance between the image pickup device and the substrate is adjusted based on the thickness of a measured substrate so that an interval between both the substrates becomes a predetermined value. Consequently, the position detecting marks of both substrates can be brought into the focal depth of the image pickup device securely.

As heretofore explained, embodiments of the present invention have been described in detail with reference to the drawings. However, the specific configurations of the present invention are not limited to the illustrated embodiments but those having a modification of the design within the scope of the claimed invention are also included in the present invention. For example, the present invention can be applied to an apparatus for detecting a position detecting mark attached to a single substrate.

Although for the first and second embodiments, an example in which the position detecting mark of the upper glass substrate 1 and the position detecting mark of the lower glass substrate 2 are positioned within the focal depth of the image pickup device 40 at the same time has been described, it is permissible to position them separately. More specifically, an allowable value set on the setting section 53 for the degree of coincidence between a photographed mark pattern and a set reference mark is set up at a higher value as compared to a case where the position detecting marks of both the substrates 1, 2 are positioned within the focal depth of the image pickup device 40, for example, 100% in terms of the degree of coincidence or a similar value. The position detecting marks of the respective substrates 1, 2 are photographed with the image pickup device 40 individually based on this allowable value in steps (1)-(5) according to the first and second embodiments so as to detect its position. Consequently, a high accuracy mark position detection is enabled, thereby providing a further effect that the position detecting accuracy is improved.

As the adhesive for adhering the two substrates together, not only an adhesive having a sealing performance but also an adhesive having no sealing performance may be used.

Further, as the substrate, it is permissible to employ not only a glass substrate which is part of a liquid crystal display panel, but also a printed substrate or the like can be used.

As described above, the present invention enables a position detecting mark on a substrate to be photographed with the image pickup device securely. Consequently, the present invention aims to prevent from reducing the rate of operation of substrate laminating work.

Although the invention has been illustrated and described with respect to exemplary embodiments thereof, it should be understood by those skilled in the art that the foregoing and various other changes, omissions and additions may be made to the present invention without departing from the spirit and scope thereof. Therefore, the present invention should not be understood as limited to the specific embodiments set out above, but should be understood to include all possible embodiments which can be embodied within a scope encompassed and equivalents thereof with respect to the features set out in the appended claims.

What is claimed is:

1. A substrate laminating apparatus having an upper stage for holding an upper substrate and a lower stage for holding a lower substrate and for laminating together the upper substrate and the lower substrate in a condition that both of the substrates have been positioned relative to each other, the substrate laminating apparatus further comprising:
an image pickup device for photographing a position detecting mark on at least one substrate of the upper and lower substrates;
a moving device for changing a relative distance between the image pickup device and the at least one substrate;
a data acquiring device which acquires data about the relative distance between the at least one substrate and the image pickup device; and
a control device for controlling the moving device based on acquired data about the relative distance.

2. A substrate laminating apparatus having an upper stage for holding an upper substrate and a lower stage for holding a lower substrate, and laminating together the upper substrate and the lower substrate in a condition that both of the substrates have been positioned relative to each other, the substrate laminating apparatus further comprising:
an image pickup device for photographing a position detecting mark on at least one substrate of the upper and lower substrates;
a moving device for changing a relative distance between the image pickup device and the at least one substrate;
an image processing device for computing a degree of coincidence between a mark pattern acquired by the image pickup device and a set reference mark pattern; and
a control device for controlling the moving device based on the computed degree of coincidence.

3. The substrate laminating apparatus according to claim 2, further comprising:
a setting section for setting an allowable value for the degree of coincidence; and
a comparing section for comparing the computed degree of coincidence with the set allowable value,
and wherein the control device controls the moving device under the condition that the computed degree of coincidence has deviated from the set allowable value and changes the relative distance between the substrate and the image pickup device by a predetermined set amount.

4. The substrate laminating apparatus according to claim 2, further comprising:
a memory section for storing data expressing a relation between a relative distance between at least one of (i) an image pickup device and a substrate photographed by the image pickup device and (ii) a relative distance adjustment amount and a degree of coincidence corresponding thereto,
and wherein the control device sets a relative distance changing amount between the substrate and the image pickup device by the moving device based on data stored in the memory section.

5. The substrate laminating apparatus according to claim 3, further comprising:
a memory section for storing data expressing a relation between a relative distance between at least one of (i) an image pickup device and a substrate photographed by the image pickup device and (ii) a relative distance adjustment amount and a degree of coincidence corresponding thereto,
and wherein the control device sets a relative distance changing amount between the substrate and the image pickup device by the moving device based on data stored in the memory section.

6. A substrate laminating method for laminating together an upper substrate held by an upper stage with a lower substrate held by a lower stage in a condition that both of the substrates have been positioned relative to each other, the substrate laminating method comprising the steps of:
photographing a position detecting mark of at least one substrate of the upper and lower substrates;
computing a degree of coincidence between a photographed mark pattern and a set reference mark pattern; and
changing a relative distance between the image pickup device and the at least one substrate based on a computed degree of coincidence.

7. The substrate laminating method according to claim 6, further comprising the steps of:
setting an allowable value about the degree of coincidence;
comparing the computed degree of coincidence with the set allowable value; and
when the computed degree of coincidence has deviated from the set allowable value, changing the relative distance between the image pickup device and the substrate only by a predetermined set amount; and
photographing the position detecting mark of the substrate again and computing the degree of coincidence between the last photographed mark pattern and the reference mark pattern.

8. A substrate laminating apparatus having an upper stage for holding an upper substrate and a lower stage for holding a lower substrate and for laminating together the upper substrate and the lower substrate in a condition that both of the substrates are positioned relative to each other, the substrate laminating apparatus further comprising:
an image pickup device for photographing a position detecting mark at least one substrate of the upper and lower substrates;
a moving device for changing a relative distance between the image pickup device and the at least one substrate;
a thickness measuring device for measuring a thickness of the at least one substrate; and
a control device for controlling the moving device based on a measurement result of the thickness measuring device.

9. The substrate laminating apparatus according to claim 8, wherein:
the thickness measuring device specifies the thickness of each of the upper and lower substrates; and
the control device controls the moving device based on a measurement result of the thickness measuring device so that a distance between both the substrates becomes a predetermined value and a distance between both the substrates and the image pickup device becomes a target relative distance.

10. A substrate laminating method for laminating together an upper substrate held by an upper stage and a lower substrate held by a lower stage in a condition that both of the substrates are positioned relative to each other, the substrate laminating method comprising the steps of:
measuring the thickness of a substrate to be held;
adjusting a relative distance between the image pickup device and at least one substrate based on the thickness of the measured substrate; and
photographing a position detecting mark of the at least one substrate.

11. A substrate laminating method for laminating together an upper substrate held by an upper stage and a lower substrate held by a lower stage in a condition that both of the substrates are positioned relative to each other, the substrate laminating method comprising the steps of:
measuring the thickness of the upper substrate and the lower substrate; and
adjusting a relative distance between the image pickup device and a substrate based on a measured substrate thicknesses so that a distance between both of the substrates becomes a predetermined value and a distance between the both substrates and the image pickup device becomes a target relative distance.

12. A substrate detecting apparatus for detecting a position of a substrate, comprising:
an image pickup device for photographing a position detecting mark of a substrate;
a moving device for changing a relative distance between the image pickup device and the substrate;
a data acquiring device which acquires data about a relative distance between the substrate and the image pickup device; and
a control device for controlling the moving device based on acquired data about the relative distance.
